(19) United States
(12) Patent Application Publication
(10) Pub. No.: US 2008/0002273 A1
(43) Pub. Date: Jan. 3, 2008

(54) Medium storing apparatus and medium storing system

(75) Inventor: Hiroshi Fujiwara, Kato (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/582,510

(22) Filed: Oct. 18, 2006

(30) Foreign Application Priority Data
Jun. 13, 2006 (JP) 2006-163497

(51) Int. Cl. G11B 19/02

(52) U.S. Cl. 360/69

(57) ABSTRACT

To provide a medium storing apparatus and a medium storing system capable of realizing a management of information recording media even when an identifier for specifying the information recording media is not attached to the information recording media such as a magnetic tape. When the medium storing apparatus determines that the identifier of the information recording media can not be read (S104: YES), each kind of data is read from a memory of the information recording media (S105), and whether or not the identifier is included in each kind of data is determined (S106), and when it is so determines that the identifier is included (S106: YES), the identifier thus read is outputted (S107), and when it is so determines that the identifier is not included (S106: NO), the identifier based on the information read in step S105 is generated.

### CROSS-REFERENCE OF RELATED APPLICATION

This nonprovisional application claims priority under 35 U.S.C. §119(a) on Patent Application No. 2006-163497 in Japan on Jun. 13, 2006, the entire contents of which are hereby incorporated by reference.

### BACKGROUND OF THE INVENTION

The present invention relates to a medium storing apparatus having a storage mechanism for storing a plurality of information recording media that can record information, and a mount/demount mechanism for mounting and demounting the information recording media stored in the storage mechanism, and a medium storing system having the medium storing apparatus, and particularly relates to the medium storing apparatus and the medium storing system used in a management of a storage position of the information recording media.

Various kinds of information recording media have been developed as recording media for backup of information which is recorded in a computer. Particularly, a plurality of information recording media using a magnetic tape excellent in the point of versatility, reliability, and recording capacity are adopted to become a large-scale system.

As a standard of the magnetic tape of high speed and large capacity, for example, an LTO (Linear Tape Open) standard devised jointly by IBM corporation, Hewlett-Packard corporation, and Seagate Technology corporation is used. The LTO standard is a tape standard that enables large capacity storage, aims at reading and writing of data at high speed, and includes two kinds, if roughly classified, such as “LTO Ultrium” directed to a memory of large capacity and “LTO Accelis” directed to reading and writing at high speed.

There are provided the medium storing apparatus storing a plurality of information recording media in which the magnetic tape pursuant to the LTO standard is housed in a casing (cartridge), and the medium storing system using a recording apparatus connected to the medium storing apparatus, and these techniques attract attention. The medium storing apparatus comprises a storage mechanism for storing the plurality of information recording media, and a mount/demount mechanism for mounting and demounting the information recording media stored in the storage mechanism, the recording apparatus comprises a database for recording the storage position of the information recording media, and the database is managed by executing a software for backup.

A manager, who manages the information recording media by using the medium storing system, assigns identification information for identifying the information recording media, converts the assigned identification information into identifier such as barcode data, and attaches the barcode data to an identification part provided at a prescribed position of the casing of the information recording media. The mount/demount mechanism has a function to read the identifier of the information recording media, and can display the identification information based on the identifier thus read from the information recording media on a displayer such as an operator panel. In addition, the mount/demount mechanism can transfer each kind of data to the recording apparatus by a communication method based on an interface standard such as a SCSI (Small Computer System Interface). The recording apparatus records the received identification information so as to correspond to the storage position of the information recording media as specifying data for specifying the information recording media, by processing of the software for backup. In this way, in the medium storing system, the medium storing apparatus and the recording apparatus can recognize each information recording medium based on the same specifying data.

Also, as a method of managing the information, Japanese Patent Application Laid-Open No. 10-269120 discloses a file management system for managing an image file by using the identifier of an image recording apparatus and the identifier of the computer, in a system for transmitting to the computer the image photographed by the image recording apparatus.

### BRIEF SUMMARY OF THE INVENTION

However, when the identifier such as barcode data is not attached to the information recording media, a problem involved therein is that although the mount/demount mechanism of the medium storing apparatus can recognize an existence of the information recording media, it can not read the identification information assigned to the information recording media.

In view of the above-described circumstances, the present invention is provided, and an object of the present invention is to provide the medium storing apparatus capable of managing the storage position by specifying the information recording media, even if the information recording media don't have the identifier attached thereto, by replacing the specifying data based on the information stored in the memory such as a non-contact nonvolatile memory provided in the information recording media beforehand, with the identification information of the information recording media, and the medium storing system having the medium storing apparatus.

### Means for Solving the Problem

In a first aspect, a medium storing apparatus is provided, comprising: a storage for storing a plurality of information recording media, each information recording medium having an identification part for showing an identifier and a memory for storing data; and a mount/demount mechanism for mounting/demounting said information recording media which are to be stored/stored in the storage, wherein said mount/demount mechanism includes: a unit for reading said identifier shown in the identification part of said information recording media; and a unit for reading the data stored in said memory, said medium storing apparatus further comprises: an output unit, when one of the identifier shown in said identification part and the data stored in said memory is read, for outputting specifying data for specifying said information recording medium based on the read one; and a processor, when both of the identifier shown in said identification part and the data stored in said memory is read, for collating both of them; and said output unit performs an output based on a result of collation.

According to the present invention, by using not only the identifier shown in the identification part but also the data stored in the memory, the information recording media can be managed. In addition, an output determined in accordance with collation results of the identifier and the data stored in the memory, such as a manipulation of the specifying data can be detected, and its result can be outputted.

In a second aspect, a medium storing apparatus is provided, comprising: a storage for storing a plurality of information recording media, each information recording medium having an identification part for showing an identifier and a memory for storing data; and a mount/demount mechanism for mounting/demounting said information recording media which are to be stored/stored in the storage, wherein said mount/demount mechanism includes: a unit for reading said identifier shown in the identification part of said information recording media; and a unit for reading the data stored in said memory, said medium storing apparatus further comprises: an output unit for outputting specifying data for specifying said information recording medium; and a processor for determining whether or not the identifier is to be read by the unit for reading said identifier from said identification part, and when the identifier is to be read, said output unit performs an output of said specifying data based on the read identifier and when the identifier is not to be read, said output unit performs an output of said specifying data based on the data of the read memory.

According to the present invention, when the identification data can not be read from the identification part, the identification data can be replaced with the data stored in the memory.

In a third aspect, the medium storing apparatus is provided according to either of the first aspect or the second aspect, wherein said memory stores manufacturing data on a manufacture of said information recording medium, said unit for reading the data reads said manufacturing data previously stored in the memory, said medium storing apparatus comprises a processor for generating said specifying data based on the read manufacturing data, and said memory stores the generated specifying data.

According to the present invention, the data to be the specifying data can be automatically generated based on the manufacturing data.

In a fourth aspect, the medium storing apparatus according to any one of the first aspect to the third aspect is provided, wherein said information recording medium includes a casing for housing a magnetic tape therein, the magnetic tape recording information, and said identification part located in said casing shows said identifier which is barcode data.

The present invention can be applied to the information recording media based on the LTO standard, capable of having a barcode data attached thereto, for example.

In a fifth aspect, a medium storing system is provided, comprising: the medium storing apparatus according to any one of the first aspect to fourth aspect; and a recording apparatus for recording a storage position of said information recording medium stored in the storage, wherein the recording apparatus includes: an receiving unit for receiving an output of said specifying data from said medium storing apparatus as an input; and a recording unit for recording the received specifying data so as to correspond to the storage position of said information recording medium.

According to the present invention, the information recording media can be managed by using the data stored in the memory, and there is no necessity of a particular design change on the side of the recording apparatus, such as a change of an interface to be connected to the medium storing apparatus.

The medium storing apparatus and the medium storing system according to the present invention are used in the medium storing apparatus comprising the storage mechanism for storing a plurality of information recording media, and the mount/demount mechanism for mounting and demounting the information recording media thus stored in the storage mechanism. The recording apparatus is connected to the medium storing apparatus by a connection line based on the interface standard such as an SCSI, etc. The information recording media can show the identifier in the identification part by a method such as attaching the barcode data, and have the memory for storing the data such as manufacturing data on the manufacture of the information recording media. The mount/demount mechanism has a function to read the identifier shown in the identification part and the data stored in the memory, and outputs to the recording apparatus the specifying data based on the identifier and the specifying data based on the data thus read from the memory, as the data for specifying the information recording media. The recording apparatus records the specifying data thus inputted so as to correspond to the storage position.

With this structure, according to the present invention, even when the identifier is not shown in the information recording media, the specifying data based on the data stored in the memory can be used. Therefore, an excellent effect is exerted, such that it is possible to manage the information recording media stored by using the specifying data that can be identified by both of the medium storing apparatus and the recording media. In addition, the specifying data outputted to the recording apparatus from the medium storing apparatus is outputted based on the same interface standard, in either case of the specifying data based on the identifier or the specifying data based on the data stored in the memory. Therefore, there is no necessity of design change in particular on the side of the recording apparatus, thus exhibiting an excellent effect such as preventing an increase of various costs such as design cost, development cost, manufacturing cost, and operative cost.

Further, in the medium storing apparatus and the medium storing system according to the present invention, when the mount/demount mechanism reads both of the identifier shown in the identification part and the data stored in the memory, both data are collated. Thus, the excellent effect can be exhibited in the output in accordance with the collation result, such that when the both data coincide with each other, the specifying data based on the identifier is outputted, and when the both data do not coincide with each other, the data in this case is regarded as manipulation or breakage, and it is possible to output of data showing occurrence of abnormality.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing a structure of a medium storing system according to an embodiment of the present invention;

FIG. 2 is a schematic view showing the structure of a medium storing apparatus according to the embodiment of the present invention;

FIG. 3 is an explanatory view conceptually showing a recording content of a cartridge memory attached to the information recording media used in the medium storing system according to the embodiment of the present invention;

FIG. 4 is a flowchart showing a particular processing of the information recording media of the medium storing apparatus according to the embodiment of the present invention;

FIG. 5 is a flowchart showing a specifying data recording processing of a recording apparatus according to the embodiment of the present invention;

FIG. 6 is a flowchart showing a specifying data reading and collation processing of the medium storing apparatus according to the embodiment of the present invention; and

FIG. 7 is a flowchart showing the specifying data reading and the collation processing of the medium storing apparatus according to the embodiment of the present invention.

### DETAILED DESCRIPTION OF THE INVENTION

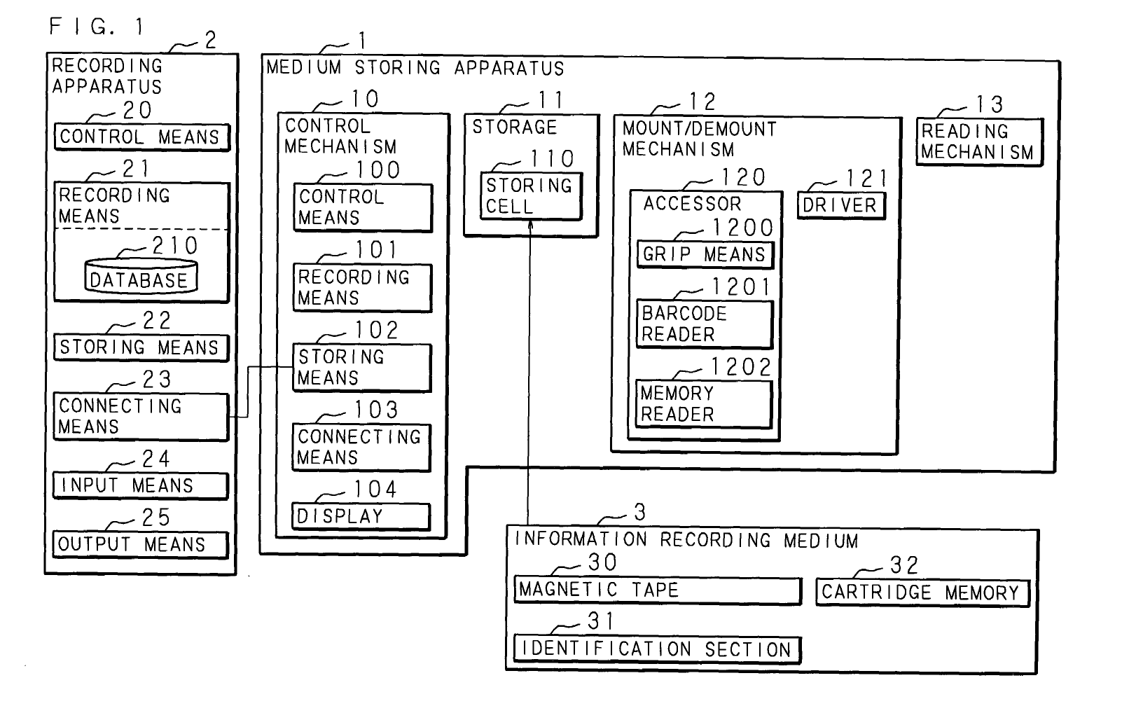

The present invention will be described in detail hereunder based on the drawings showing its embodiment. FIG. 1 is a block diagram showing a structure of a medium storing system according to this embodiment. Numeration mark “1” in FIG. 1 indicates a medium storing apparatus, and a recording apparatus 2, in which a computer such as a personal computer is used, is connected to the medium storing apparatus 1 by a connection line based on an interface standard such as an SCSI (Small Computer System Interface).

The medium storing apparatus 1 comprises a control mechanism 10 for controlling an overall device, a storage mechanism (storage part) 11 having a storage cell 110 for storing a plurality of information storage media 3 such as a magnetic tape based on a standard such as an LTO (Linear Tape Open) respectively, a mount/demount mechanism 12 for mounting and demounting the information recording media 3 stored in the storage mechanism 11, and a recording and reading mechanism 13 for recording and reading the information in/from the information recording media 3.

The information recording media 3 based on the LTO standard is constituted so as to record the information in a magnetic tape 30 housed in a casing (cartridge). Identification information for identi fying the information recording media 3 by a manager is assigned to the information recording media 3, and the identification information thus assigned is attached to an identification part 31 provided at a prescribed position of the casing as the identifier such as barcode data. In addition, a cartridge memory (memory) 32 using a non-volatile memory for recording and reading information by non-contact is attached to the casing.

The control mechanism 10 comprises a controller 100 such as a CPU, a recording unit 101 such as an ROM for recording the information such as each kind of program and data executed by the controller 100, a storage unit 102 such as an RAM for recording the data temporarily generated on executing the program, a connecting unit (an output unit) 103 such as an SCSI board for connecting and communicating with a recording apparatus 2, and a displayer 104 such as a liquid crystal panel for displaying each kind of information.

The mount/demount mechanism 12 comprises an accessor 120 for gripping, mounting, demounting, and moving the information recording media 3, and a driving unit 121 for driving the accessor 120 and positioning it to the storage cell, and the accessor 120 has arranged therein a gripping unit 1200 for gripping the information recording media 3, a barcode data reading unit (unit for reading the identifier) 1201 such as a barcode reader for reading the identifier attached to the identification part 31 of the casing of the information recording media 3, and a memory data recording and reading unit (unit for reading the data stored in the memory) 1202 for reading and recording the data on the cartridge memory (memory) 32.

The recording apparatus 2 comprises a controller 20, a recording unit 21 such as a hard disk, a storage unit 22, a connection unit (an input unit) 23, an input unit 24 such as a mouse and a keyboard, and an output unit 25 such as a monitor and a printer, and a part of a recording area of the recording unit 21 is used as a database 210 for recording the storage position in the storage mechanism 11 for storing the information recording media 3 and the specifying data for specifying the information recording media 3 so as to coincide with each other.

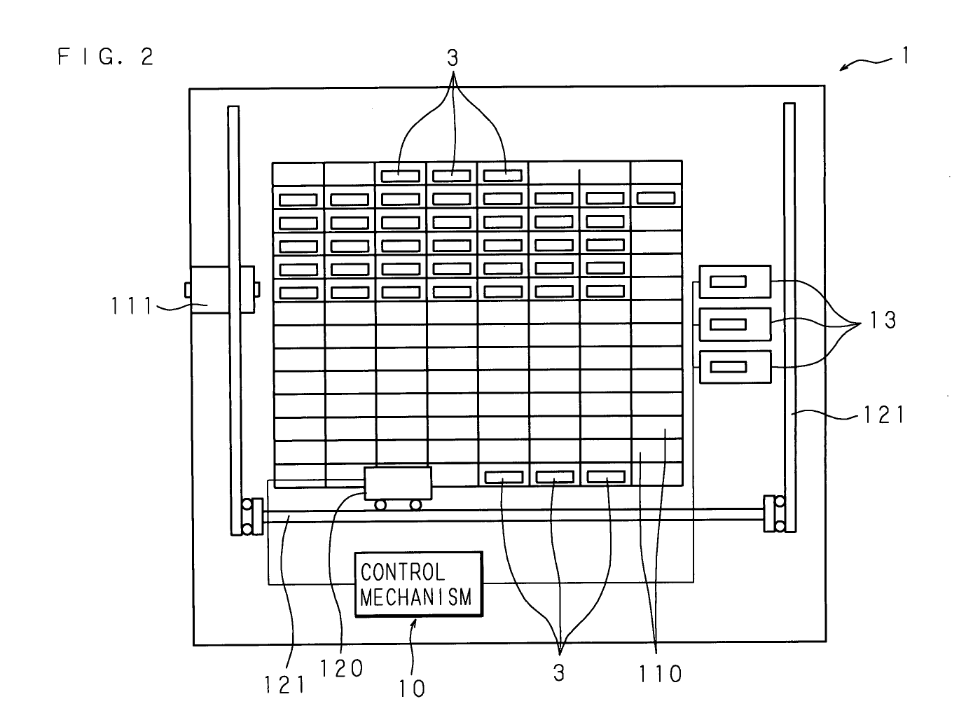

FIG. 2 is a schematic diagram showing the structure of the medium storing apparatus 1 according to this embodiment. The storage mechanism 11 provided in the medium storing apparatus 1 comprises the storage cell 110 for storing a plurality of information recording media 3 respectively, a charge/discharge port 111 for charging and discharging the information recording media 3 from the outside, and the recording and reading mechanism 13.

The mount/demount mechanism 12 provided in the medium storing apparatus 1 comprises the accessor 120 for gripping, mounting and demounting, and moving the information recording media 3, and the driving unit 121 for driving the accessor 12 by a lateral moving rail and a longitudinal moving rail.

By driving the accessor 120 by the driving unit 121 of the mount/demount mechanism 12, the accessor 120 is moved, and the accessor 120 performs positioning of the storage mechanism 11 with respect to the storage cell 110, and performs mounting and demounting of the information recording media 3 into/from the storage position designated by the storage cell 110. The driving unit 121 performs transfer of the information recording media 3 between the storage cell 110, the charge/discharge port 111, and the recording reading mechanism 13 by moving the accessor 120 that grips the information recording media 3.

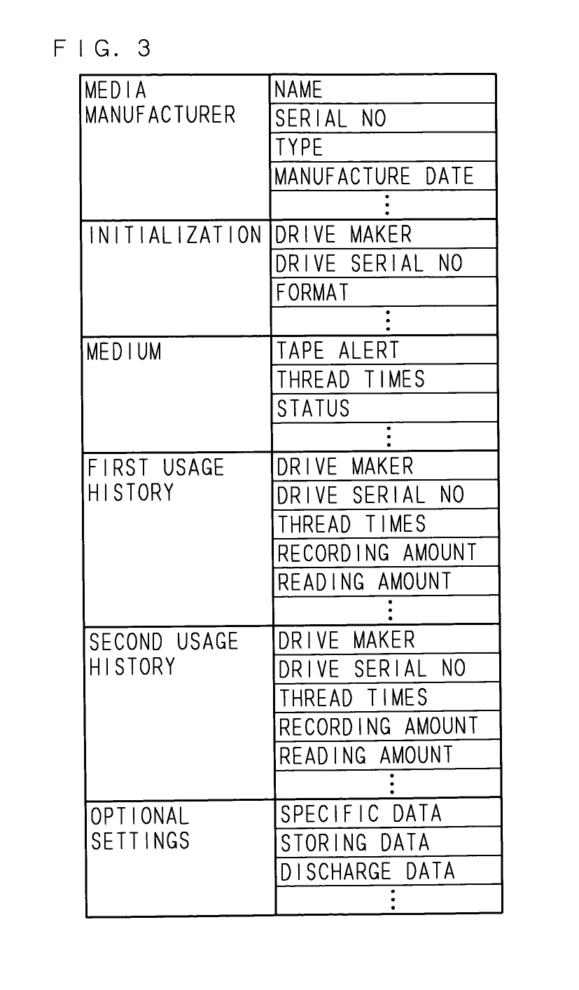

FIG. 3 is an explanatory view conceptually showing a recording content of the cartridge memory 32 attached to the information recording media 3 used in the medium storing system according to this embodiment. The cartridge memory 32 stores unrewritable data that is written on manufacturing the information recording media 3, such as media manufacturing source information on manufacturing of the information recording media 3, initialization information that can be rewritten, media information, first use history information and second use history information, and arbitrary setting information.

As the media manufacturing source information, the information on the manufacture is stored, such as the information on manufacturer's name who manufactures the information recording media 3, unique serial number assigned when manufacturing the information recording media, types of cartridge, manufacturing date, and the storage content and storage form of the above information are set beforehand as a standard.

As the initialization information, the manufacturer's name of an initialized drive, the serial number of the initialized drive, and rewritable information on the initialization of a format type, etc., are stored, and the storage content and storage form of the above information are set beforehand as a standard.

As the media information, the rewritable information on media such as tape alert, the number of times of threads, and media condition, etc., are stored, and the storage content and storage form of the above information are set beforehand as a standard.

As the first use history information, the rewritable information on a use history such as the manufacturer's name of loaded drive, the serial number of the loaded drive, the number of times of threads, an amount of recording information, and an amount of reading information, is stored, and the storage content and storage form of the above information is set beforehand as a standard.

The second use history information is substantially the same as the first use history information, and for example, after initialization, it is used when the information recording media 3 are used for an application which is different from the preceding application.

The arbitrary setting information is the information which can be set on the side of the user, and in the medium storing system according to this embodiment, the specifying data for specifying the information recording media 3, time and date stored in the medium storing apparatus 1, and the rewritable information such as the time and date discharged from the medium storing apparatus 1 are stored.

Next, the processing of the medium storing system according to this embodiment will be explained.

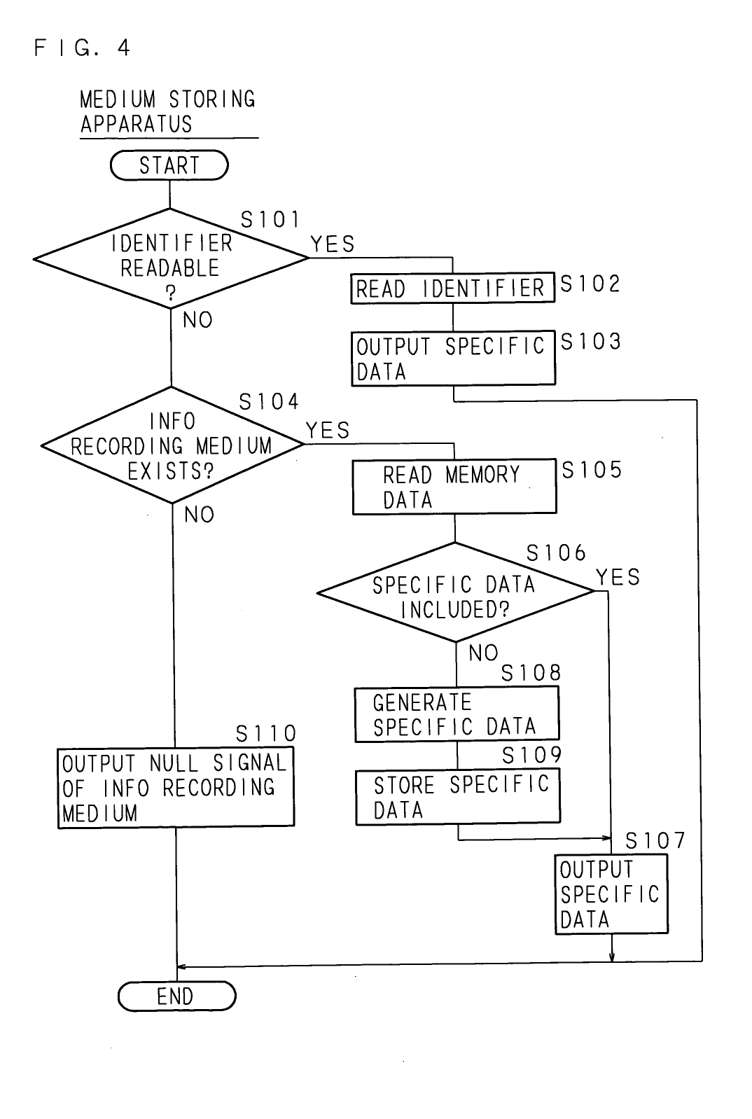

FIG. 4 is a flowchart showing a particular processing of the information recording media of the medium storing apparatus 1 according to this embodiment. The medium storing apparatus 1 according to this embodiment executes the particular processing of the information recording media when gripping the information recording media 3 such as when the information recording media 3 is charged from the charge/discharge port 111 of the storage mechanism 11, and when the information recording media 3 inserted into the storage cell 110 is discharged.

The medium storing apparatus 1 allows the accessor 120 of the mount/demount mechanism 12 to approach the information recording media 3 to be specified, by a control of the control mechanism 10. The accessor 120 of the mount/demount mechanism 12 tries to read the identifier from the identification part 31 of the information recording media 3 (S101). In an attempt of step S101, when the identifier such as a barcode data is attached to the identification part 31 as a barcode label, the accessor 120 can read the identifier.

In step S101, when the accessor 120 determines that the identifier can be read (S101: YES), the accessor 120 of the mount/demount mechanism 12 provided in the medium storing apparatus 1 reads the identifier from the identification part 31 by the barcode data reading unit 1201 (S102), and outputs the identifier thus read to the recording apparatus 2 from the connecting unit 103 of the control mechanism 10, as the specifying data for specifying the information recording media 3 (S103). In addition, the control mechanism 10 displays (outputs) the specifying data to the displayer 104.

In step S101, when the accessor 120 determines that the identifier can not be read (S101: NO), the accessor 120 of the mount/demount mechanism 12 provided in the medium storing apparatus 1 tries to grip the information recording media 3 by the gripping unit 1200, and thereby determines the existence/non-existence of the information recording media 3 (S104). In step S104, when the information recording media 3 can be gripped, the accessor 120 determines that the information recording media 3 exists.

In step S104, when the accessor 120 determines that the information recording media 3 exist (S104: YES), the accessor 120 of the mount/demount mechanism 12 provided in the medium storing apparatus 1 reads each kind of data such as media manufacturing source information and arbitrary setting information stored in the cartridge memory 32 attached to the information recording media 3, by the memory data recording and reading unit 1201 (S105), and determines whether or not the specifying data for specifying the information recording media 3 is included in the arbitrary setting information included in each kind of data thus read (S106). In step S106, the accessor 120 determines whether or not the specifying data is stored in the cartridge memory 32 of the information recording media 3.

In step S106, when the accessor 120 determines that the specifying data is included (S106: YES), the accessor 120 of the mount/demount mechanism 12 provided in the medium storing apparatus 1 outputs the specifying data thus read from the cartridge memory 32 to the recording apparatus 2 from the connecting unit 103 of the control mechanism 10, as the specifying data for specifying the information recording media 3 (S107). In addition, the control mechanism 10 displays (outputs) the specifying data to the displayer 104.

In step S106, when the accessor 120 determines that the specifying data is not included (S106: NO), the mount/demount mechanism 12 provided in the medium storing apparatus 1 generates the specifying data for specifying the information recording media 3, based on the information of the serial number, etc., which is the media manufacturing source information read in step S105 (S108), and allows the memory data recording and reading unit 1201 to store the specifying data thus generated in the recording area of the arbitrary setting information of the cartridge memory 32 (S109). Then, the processing is advanced to step S107, and the specifying data is outputted to the recording apparatus 2 (S107). In addition, the control mechanism 10 displays (outputs) the specifying data to the displayer 104. In step S108, a unique specifying data is generated from the media manufacturing source information of the serial number, etc., by following a calculation method previously set.

In step S104, when the accessor 120 determines that the information recording media 3 do not exist (S104: NO), the accessor 120 of the mount/demount mechanism 12 provided in the medium storing apparatus 1 outputs to the recording apparatus 2 an information recording media non-signal whereby a message is reported such that the information recording media 3 are not stored in the designated storage position (S110).

Thus, the medium storing apparatus 1 according this embodiment outputs the information generated based on the barcode data or the media manufacturing source information, as the specifying data for specifying the information recording media 3.

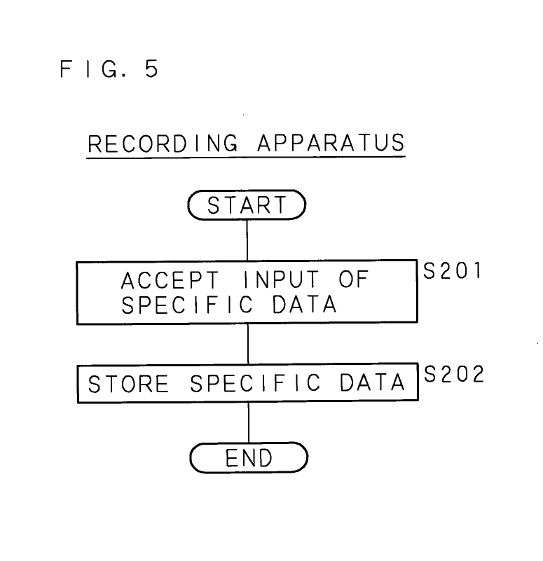

FIG. 5 is a flowchart showing a specifying data recording processing of the recording apparatus 2 according to this embodiment. By the connecting means 23, the recording apparatus 2 receives an input of the specifying data outputted from the medium storing apparatus 1 under the control of the controller 20 (S201), and records the specifying data thus received in the database 210 so as to correspond to the storage position for storing the information recording media 3 (S202). Note that when not the input of the specifying data but the input of the information recording media non-signal is received, the data showing that the information recording media 3 do not exist is recorded in the database 210 so as to correspond to the storage position. In various processing thereafter, the recording apparatus 2 manages the information recording media 3 by using the specifying data.

Although the aforementioned embodiment shows that either one of the data stored in the identifier or the data stored in the cartridge memory 32 is read and used as the specifying data, both of them can be read. Also, in this case, it is possible that the calculation method for the generation of the specifying data is previously set so as to make the both data be the same and collation processing is performed to detect the manipulation or breakage of the specifying data.

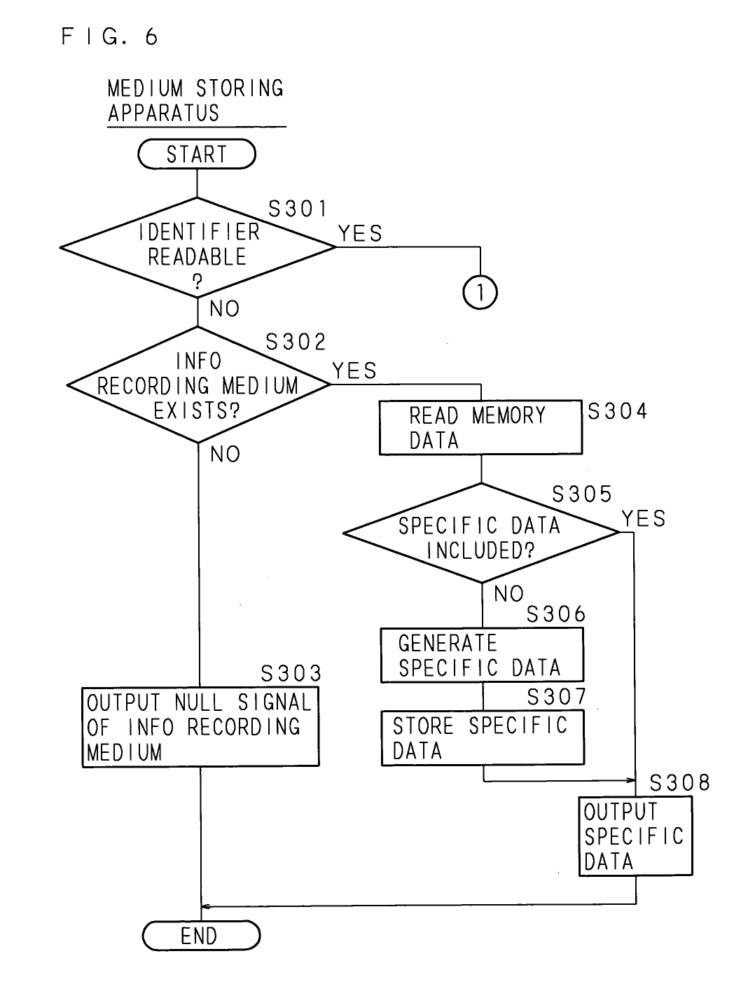

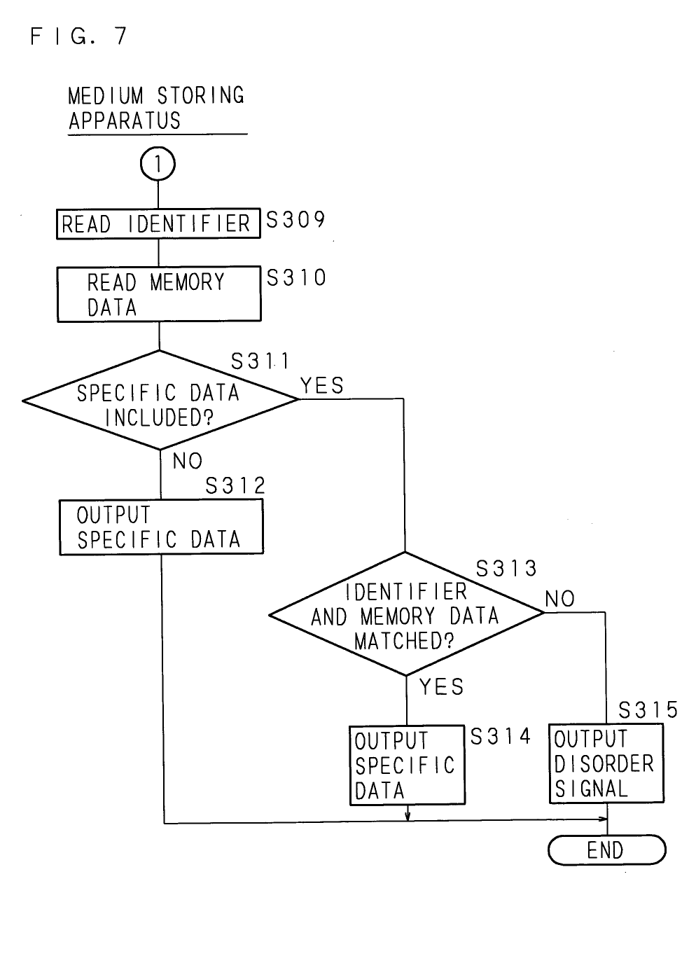

FIG. 6 and FIG. 7 are flowcharts showing the reading of the specifying data and collation processing of the medium storing apparatus 1 according to this embodiment. The medium storing apparatus 1 allows the accessor 120 of the mount/demount mechanism 12 to approach the information recording media 3 to be specified, by the control of the control mechanism 10. The accessor 120 of the mount/demount mechanism 12 tries to read the identifier from the identification part 31 of the information recording media 3 (S301).

In step S301, when the accessor 120 determines that the identifier can not be read (S301: NO), the accessor 120 of the mount/demount mechanism 12 provided in the medium storing apparatus 1 tries to grip the information recording media 3 by the gripping unit 1200, and determines the existence and non-existence of the information recording media 3 (S302).

In step S302, when the accessor 120 determines that the information recording media 3 do not exist (S302: NO), the accessor 120 of the mount/demount mechanism 12 provided in the medium storing apparatus 1 outputs to the recording apparatus 2 the information recording media non-signal whereby the message is reported such that the information recording media 3 are not stored in the designated storage position (S303).

In step S302, when the accessor 120 determines that the information recording media 3 exist (S302: YES), the accessor 120 of the mount/demount mechanism 12 provided in the medium storing apparatus 1 reads each kind of data stored in the cartridge memory 32 attached to the information recording media 3 by the memory data recording and reading unit 1201 (S304), and determines whether or not the specifying data for specifying the information recording media 3 is included in the arbitrary setting information included in each kind of read data (S305).

In step S305, when the accessor 120 determines that the specifying data is not included (S305: NO), the mount/demount mechanism 12 provided in the medium storing apparatus 1 generates the specifying data for specifying the information recording media 3 by following a rule previously set such as conversion based on a prescribed calculation method for the media manufacturing source information read in step S304 (S306), allows the memory data recording and reading unit 1201 to store the specifying data thus generated in the recording area of the arbitrary setting information of the cartridge memory 32(S307), and outputs the specifying data to the recording apparatus 2 (S308). In addition, the control mechanism 10 displays (outputs) the specifying data on (to) the displayer 104.

In step S305, when the accessor 120 determines that the specifying data is included (S305: YES), the processing is advanced to step S308, and the specifying data thus read from the cartridge memory 32 is outputted to the recording apparatus 2 (S308).

In step S301, when the accessor 120 determines that the identifier can be read (S301: YES), the accessor 120 of the mount/demount mechanism 12 provided in the medium storing apparatus 1 reads the identifier from the identification part 31 by the barcode data reading unit 1201 (S309), further reads each kind of data stored in the cartridge memory 32 attached to the information recording media 3 by the memory data recording and reading unit 1201 (S310), and determines whether or not the specifying data for specifying the information recording media 3 is included in the arbitrary setting information included in each kind of read data (S311).

In step S311, when the accessor 120 determines that the specifying data is not included (S311: NO), the mount/demount mechanism 12 provided in the medium storing apparatus 1 outputs the identifier read from the identification part 31 to the recording apparatus 2 as the specifying data (S312).

In step S311, when the accessor 120 determines that the specifying data is included (S311: YES), the accessor 120 of the mount/demount mechanism 12 provided in the medium storing apparatus 1 collates whether or not the specifying data read from the cartridge memory 32 and the specifying data which is the identifier read from the identification part 31 coincide with each other (S313).

In step S313, as a result of the collation, when the accessor 120 determines that both specifying data coincide with each other (S313: YES), the mount/demount mechanism 12 provided in the medium storing apparatus 1 outputs the specifying data to the recording apparatus 2 (S314). In addition, the control mechanism 10 displays (outputs) the specifying data (on) to the displayer 104. In step S314, although the specifying data based on the identifier is outputted, both of the specifying data coincide with each other. Therefore, similar specifying data is outputted whichever of them is outputted.

In step S313, as a result of collation, when the accessor 120 determines that both of the specifying data do not coincide with each other (S313: NO), the mount/demount mechanism 12 provided in the medium storing apparatus 1 outputs to the recording apparatus 2 an abnormal signal of an abnormal message showing that abnormality such as a manipulation and breakage occurs to at least one of the specifying data (S315), and the processing is ended. In addition, the control mechanism 10 displays (outputs) the message according to the abnormal signal on (to) the displayer 104.

In addition, in step S313, when the accessor 120 determines that the both of the specifying data do not coincide with each other, it may be so designed that not the abnormal signal is outputted but both of the specifying data are outputted, and one of the specifying data previously set, for example, the specifying data based on the identifier may be outputted.

In this way, when the medium storing apparatus 1 according to this embodiment reads either one of the identifier shown in the identification part 31 or the data stored in the cartridge memory 32, the specifying data based on one of the data thus read is outputted. Note that when either one of the data is read, by setting the other data so as to show the same specifying data as one of the data thus read, the collation processing can be performed by the processing from the next time. In addition, when both of the identifier shown in the identification part 31 and the data stored in the memory are read, both specifying data are collated, and an output based on the collation result is executed.

The embodiment disclosed in the aforementioned embodiment only shows a part of enumerable embodiments to realize the present invention, and the present invention can be developed in various forms other than the aforementioned embodiments. For example, it may be so designed that not the specifying data is generated based on the serial number, which is the media manufacturing source information, but the serial number itself may be used as the specifying data.

Also, according to the aforementioned embodiments, the barcode data is selected to be as the identifier, and is outputted as the specifying data. However, the present invention is not limited thereto, and can be developed in various forms in such a way that the specifying data may be generated by converting the barcode data by a prescribed method, and further the data other than the barcode data, for example, ID recorded in a RFID tag may be selected as the identifier.

As this invention may be embodied in several forms without departing from the spirit of essential characteristics thereof, the present embodiment is therefore illustrative and not restrictive, since the scope of the invention is defined by the appended claims rather than by description preceding them, and all changes that fall within metes and bounds of the claims, or equivalence of such metes and bounds thereof are therefore intended to be embraced by the claims.

What is claimed is:

1. A medium storing apparatus, comprising:
a storage for storing a plurality of information recording media, each information recording medium having an identification part for showing an identifier and a memory for storing data; and
a mount/demount mechanism for mounting/demounting said information recording media which are to be stored/stored in the storage, wherein
said mount/demount mechanism includes:
a unit for reading said identifier shown in the identification part of said information recording media; and
a unit for reading the data stored in said memory, said medium storing apparatus further comprises:
an output unit, when one of the identifier shown in said identification part and the data stored in said memory is read, for outputting specifying data for specifying said information recording medium based on the read one; and
a processor, when both of the identifier shown in said identification part and the data stored in said memory is read, for collating both of them; and
said output unit performs an output based on a result of collation.

2. The medium storing apparatus according to claim 1,
wherein
said memory stores manufacturing data on a manufacture of said information recording medium,
said unit for reading the data reads said manufacturing data previously stored in the memory,
said medium storing apparatus comprises a processor for generating said specifying data based on the read manufacturing data, and
said memory stores the generated specifying data.

3. The medium storing apparatus according to claim 1,
wherein
said information recording medium includes a casing for housing a magnetic tape therein, the magnetic tape recording information, and
said identification part located in said casing shows said identifier which is barcode data.

4. The medium storing apparatus according to claim 1,
wherein
the processor determines whether or not the identifier shown in said identification part is identical with the data stored in said memory,
when the processor determines that they are identical with each other, the output unit outputs, as the specifying data, one of the identifier shown in said identification part and the data stored in said memory, and
when the processor determines that they are not identical with each other, the output unit performs an output based on a determined result.

5. The medium storing apparatus according to claim 4,
wherein
when the controller determines that the identifier shown in said identification part is not identical with the data stored in said memory, the output unit outputs a signal showing anomaly.

6. The medium storing apparatus, comprising:
a storage for storing a plurality of information recording media, each information recording medium having an identification part for showing an identifier and a memory for storing data; and
a mount/demount mechanism for mounting/demounting said information recording media which are to be stored/stored in the storage, wherein
said mount/demount mechanism includes:
a unit for reading said identifier shown in the identification part of said information recording media; and
a unit for reading the data stored in said memory,
said medium storing apparatus further comprises:
an output unit for outputting specifying data for specifying said information recording medium; and
a processor for determining whether or not the identifier is to be read by the unit for reading said identifier from said identification part, and
when the identifier is to be read, said output unit performs an output of said specifying data based on the read identifier and
when the identifier is not to be read, said output unit performs an output of said specifying data based on the data of the read memory.

7. The medium storing apparatus according to claim 6,
wherein
said memory stores manufacturing data on a manufacture of said information recording medium,
said unit for reading the data reads said manufacturing data previously stored in the memory,
said medium storing apparatus comprises a processor for generating said specifying data, based on the read manufacturing data, and
said memory stores the generated specifying data.

8. The medium storing apparatus according to claim 6,
wherein
said information recording media include a casing for housing a magnetic tape therein, the magnetic tape recording information, and
said identification part located in said casing shows said identifier which is barcode data.

9. A medium storing apparatus, comprising:
a storage for storing a plurality of information recording media having an identification part for showing an identifier and a memory for storing data; and
a mount/demount mechanism for mounting/demounting said information recording media which are to be stored/stored in the storage, wherein
said mount/demount mechanism includes:
means for reading said identifier shown in the identification part of said information recording media;
memory data reading means for reading the data stored in said memory;
means for outputting specifying data for specifying the information recording media based on one of read data, when either one of the identifier shown in said identification part or the data stored in said memory is read;
means for collating both of the identifier and the data, when both of the identifier shown in said identification part and the data stored in said memory are read; and
means for performing an output based on a collation result.

10. The medium storing apparatus according to claim 9,
wherein
said memory has means for storing manufacturing data on a manufacture of said information recording media,
said memory data reading means reads said manufacturing data previously stored in the memory, and
said mount/demount mechanism further comprises:
means for generating said specifying data, based on said manufacturing data thus read; and
means for storing said specifying data thus generated in the memory.

11. The medium storing apparatus according to claim 9,
wherein
said information recording media comprise a casing for housing a magnetic tape therein, the magnetic tape recording information, and
said identifier is barcode data attached to said identification part provided in said casing.

12. The medium storing apparatus according to claim 9,
wherein
when the unit for collation determines that the identifier shown in said identification part is identical with the data stored in said memory, the means for output outputs one of the identifier shown in said identification part and the data stored in said memory as said specifying data, and
when the means for collation determines that the identifier shown in said identification part is identical with the data stored in said memory, the unit for output outputs the data by following a collation result that they do not coincide with each other.

13. The medium storing apparatus according to claim 12, wherein
said means for output outputs a signal showing anomaly as the collation result that they is not identical with each other.

14. A medium storing apparatus, comprising:
a storage for storing a plurality of information recording media having an identification part for showing an identifier and a memory for storing data; and
a mount/demount mechanism for mounting/demounting said information recording media which are to be stored/stored in the storage, wherein
said mount/demount mechanism includes:
means for reading said identifier shown in the identification part of said information recording media;
means for trying to read the identifier from said identification part and a unit for reading the identifier from the identification part when the identifier can be read;
memory data reading means for reading the data stored in the memory when the identifier can not be read; and
means for outputting said specifying data based on the identifier read from the identification part by said mount/demount mechanism or said specifying data based on the data read from the memory.

15. The medium storing apparatus according to claim 14, wherein
said memory has means for storing manufacturing data on a manufacture of said information recording media,
said memory data reading means reads said manufacturing data previously stored in the memory, and
said mount/demount mechanism further comprises:
means for generating said specifying data, based on said manufacturing data thus read; and
means for storing said specifying data thus generated in the memory.

16. The medium storing apparatus according to claim 14, wherein
said information recording media comprise a casing for housing a magnetic tape therein, the magnetic tape recording information, and
said identifier is barcode data attached to said identification part provided in said casing.

17. A medium storing system, comprising:
the medium storing apparatus according to claim 1; and
a recording apparatus for recording a storage position of said information recording medium stored in the storage, wherein
the recording apparatus includes:
an receiving unit for receiving an output of said specifying data from said medium storing apparatus as an input; and
a recording unit for recording the received specifying data so as to correspond to the storage position of said information recording medium.

18. A medium storing system, comprising:
the medium storing apparatus according to claim 9; and
a recording apparatus for recording a storage position of said information recording media stored in the storage, wherein
the recording apparatus includes:
means for receiving an output of said specifying data from said medium storing apparatus as an input; and
means for recording the received specifying data so as to correspond to the storage position of said information recording medium.
